(19) United States
(12) Patent Application Publication
(10) Pub. No.: US 2004/0100509 A1
(43) Pub. Date: May 27, 2004

(54) Web page partitioning, reformatting and navigation

(75) Inventors: Ralph Sommerer, Cambridge (GB); Natasa Milic-Frayling, Cambridge (GB)

Correspondence Address: LEE & HAYES PLLC, 421 W RIVERSIDE AVENUE SUITE 500, SPOKANE, WA, 99201

(73) Assignee: Microsoft Corporation

(21) Appl. No.: 10/306,276

(22) Filed: Nov. 27, 2002

(51) Int. Cl. G09G 5/00; G06F 15/16

(52) U.S. Cl. 345/864; 709/246

(57) ABSTRACT

A web page partitioning module discovers and delineates logical sections within a web page creating a partition of the page. A logical section reformatting module reformats an individual logical section of the web page to fit within an incompatible display. A logical section map generation module allows a user to navigate among logical sections of a web page by displaying a map of the logical section of the web page and allowing a user to select a desired logical section for display. The web page partitioning module, the logical section reformatting module, and the logical section map generation module may reside on a client device or a server device, such as a proxy server or web server or embedded in the document authoring tools.

### TECHNICAL FIELD

The invention relates generally to resource browsers, and more particularly to partitioning and navigating through a web page.

### BACKGROUND OF THE INVENTION

Most web pages are designed for display on a desktop or laptop display screen. Such display screens have somewhat consistent sizes and aspect ratios, which allows the web page designer to make certain assumptions in the layout of text, graphics, and logical sections of the web page. For example, web pages are designed to place advertisements, controls, links, text, and other content within the anticipated bounds of a desktop or laptop display screen.

One problem with this existing approach is that the incompatible sizes and aspect ratios of handheld devices or large screen displays do not accommodate a typical web page designed for a desktop or laptop system. For example, FIG. 1 illustrates three parts of a web page 100 as shown on a handheld device at different horizontal scroll points. An article 110 from Slate, an online magazine, is too wide to be displayed on a handheld device without horizontal scrolling. To read the article 110, the user must scroll horizontally back and forth as each line of text is read. This approach has very negative usability characteristics. Users are relatively comfortable with scrolling down to read text, but users are less comfortable with horizontal scrolling (back and forth), particularly with every line of text. Likewise, if the web page is displayed on a large screen display, such as in a convention hall in which the display is zoomed in to make the text large enough for the audience members to see, repeated horizontal scrolling is unworkable for most audiences.

In addition, for web pages with multiple sections of layout, such as the page shown in FIG. 3, multiple peripheral sections may take up valuable display real estate in a handheld device or large screen display. As shown by display 102 of FIG. 1, the inclusion of section 104 in the display 102 severely limits the amount of section 110 displayed in the first horizontal position, thereby contributing to the need to scroll horizontally in order to read the article in section 110.

### SUMMARY OF THE INVENTION

Embodiments of the present invention solve the discussed problems by providing a web page partitioning module that discovers and delimits logical sections within a web page. A logical section reformatting module reformats an individual logical section of the web page to fit within an incompatible display. For example, a web page display that would previously have required horizontal scrolling to read text on the page can be reformatted to omit other logical sections and modify the layout of the section of interest in order to eliminate the need for horizontal scrolling. Furthermore, a web page partition map allows a user to navigate among logical sections of a web page.

In implementations of the present invention, articles of manufacture are provided as computer program products. One embodiment of a computer program product provides a computer program storage medium readable by a computer system and encoding a computer program that displays a web page on an incompatible display having at least two axes. Another embodiment of a computer program product may be provided in a computer data signal embodied in a carrier wave by a computing system and encoding the computer program that displays a web page on an incompatible display having at least two axes.

The computer program product encodes a computer program for executing on a computer system a computer process for displaying a web page on an incompatible display having at least two axes is provided. The web page is partitioned into one or more logical sections. A logical section of the one or more logical sections is reformatted to produce a reformatted logical section. The reformatted logical section fits within the incompatible display along at least one axis when displayed in the incompatible display. Data for displaying the reformatted logical partition in the incompatible display is generated.

In another implementation of the present invention, a method of displaying a web page on an incompatible display having at least two axes is provided. The web page is partitioned into one or more logical sections. A logical section of the one or more logical sections is reformatted to produce a reformatted logical section. The reformatted logical section fits within the incompatible display along at least one axis when displayed in the incompatible display. Data for displaying the reformatted logical partition in the incompatible display is generated.

In yet another embodiment of the present invention, a system for displaying a web page on an incompatible display having at least two axes is provided. A web page partitioning module partitions the web page into one or more logical sections. A logical section reformatting module reformats a logical section of the one or more logical sections to produce a reformatted logical section. The reformatted logical section fits within the incompatible display along at least one axis when displayed in the incompatible display. A logical section rendering module generates data for displaying the reformatted logical partition in the incompatible display.

These and various other features as well as other advantages, which characterize the present invention, will be apparent from a reading of the following detailed description and a review of the associated drawings.

### BRIEF DESCRIPTION OF THE DRAWINGS

FIG. 1 depicts three parts of a web page displayed on a handheld device at different horizontal scroll points in an embodiment of the present invention.

FIG. 2 depicts a logical section of the web page partition reformatted to be compatible with the display on a handheld device in an embodiment of the present invention.

FIG. 3 depicts a web page partition map in an embodiment of the present invention.

FIG. 4 illustrates a client-implemented embodiment of the present invention.

FIG. 5 illustrates a proxy server-implemented embodiment of the present invention.

FIG. 6 illustrates exemplary heuristics for configuring logical sections of a web page in an embodiment of the present invention.

FIG. 7 illustrates other exemplary heuristics for configuring logical sections of a web page in an embodiment of the present invention.

FIG. 8 illustrates an exemplary system useful for implementing an embodiment of the present invention.

### DETAILED DESCRIPTION OF THE INVENTION

When a web page is received for display on an “incompatible” display (i.e., a display which is incompatible with the web page's design), a web page partitioner/reformatter can partition the web page and/or reformat logical sections of the web page to fit within the incompatible display. For example, a web page may be designed with complex display features that, while appropriate for a desktop or laptop display, make the web page difficult to use on a handheld device or large screen display. By partitioning and/or reformatting logical sections of the web page, each logical section can be displayed optimally within the previously incompatible display.

One specific example of a potentially incompatible display is a handheld device with a browser, such as a Personal Digital Assistant (PDA) device (e.g., an iPAQ from Compaq). Web pages designed for a desktop or laptop display tend to horizontally overrun the limited real estate on a handheld device's display. As such, a user would typically have to scroll the web page back and forth along a horizontal axis to read text on the web page. The web page partitioner/reformatter allows the browser to display only the logical section in which the user is interested and can reformat the logical section to eliminate the need for horizontal scrolling.

Another example of a potentially incompatible display is a large screen display, such as may be used in a convention hall or conference room. Web pages designed for a desktop or laptop display tend to crowd the display with multiple logical sections. If the user zooms in to the web page to maximize the size and readability of text on the web page, other areas of the web page may be obscured. Furthermore, depending on the amount of zoom required to make the text readable to the entire audience, the desired text may overrun the screen horizontally (i.e., along a horizontal axis), requiring the undesirable use of horizontal scrolling for each line of text. Again, the web page partitioner/reformatter allows the browser to display only the logical section in which the user is interested and can reformat the logical section to eliminate the need for horizontal scrolling (e.g., using a font size that is more appropriate for a large audience in a convention hall).

Furthermore, on a web page with multiple logical sections, a web page partition map provides a convenient user interface for navigating among the logical sections of the web page. A “zoomed out” image of the web page is displayed on the device with partition lines designating individual logical sections. By selecting a logical section, a user can view the reformatted logical section in a new format that is compatible with the device's display.

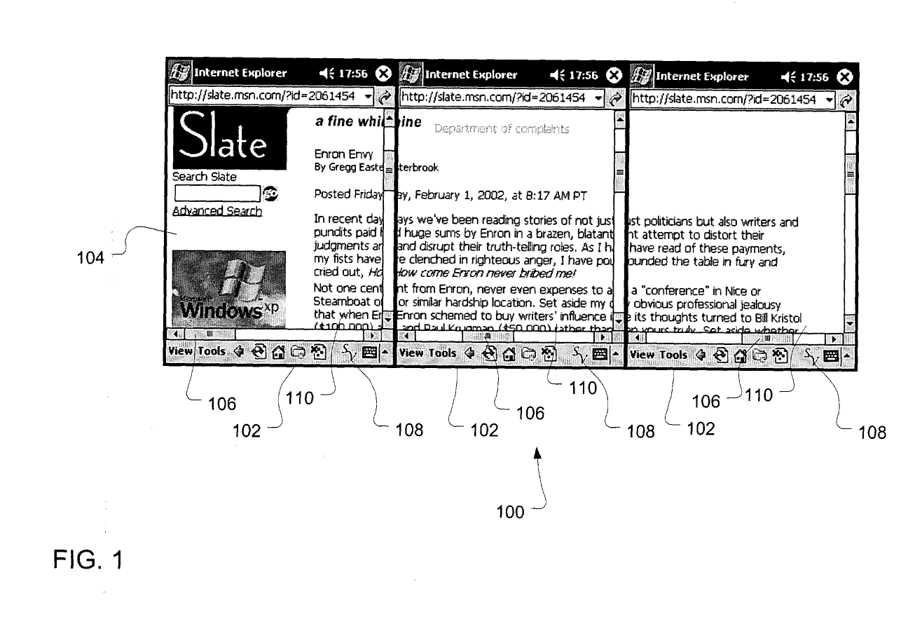

FIG. 1 depicts three parts of a web page displayed on a handheld device at different horizontal scroll points in an embodiment of the present invention. The composite display 100 is configured to illustrate how a web page, which is typically designed for display on a desktop or laptop display screen, may not adequately fit within the dimensions of a handheld device display screen 102. In fact, as can be seen on the depiction of three handheld device displays arranged side by side, the web page visualized on FIG. 1 horizontally straddles the combined width of three displays.

Within the web page illustrated in the composite drawing 100, a logical section 104 and a logical section 110 are displayed. The logical section 104 includes an image link displaying the word “Slate,” a search applet, and an advertisement link for MICROSOFT WINDOWS XP software. The logical section 110 includes an article entitled “a fine whine,” by Gregg Easterbrook. In a typical web page layout, logical sections are designated by a table layout defined in the HTML data received by the browser, however, other means of designating logical sections in a web page, such as by using paragraphs, HTML forms, HTML frames, etc. are contemplated within the scope of the present invention.

In the illustration, a user must employ horizontal scrolling, using, for example, the horizontal scroll bar 106 to read a single line of text in the article of the logical section 110. By scrolling back and forth using the horizontal scroll bar 106, the user is able to read each line of text, although this interface is inconvenient and makes reading such articles difficult. One contributing factor to this inconvenience is the incompatibility between the initial design of the web page (i.e., for a desktop or laptop display screen) and the handheld display screen dimensions and aspect ratio. Furthermore, the inclusion of the logical section 104 in the display, when the user is interested only in the article in logical section 110, further diminishes the amount of real estate available for displaying the article.

However, in the embodiment of the present invention shown in FIG. 1, a special “SmartView” (“ [symbol] ”) control 108 allows the user to switch into SmartView mode for viewing the web page on the handheld device. In another embodiment, the user switches into SmartView mode using a tap-and-hold menu by selecting the “SmartView” option.

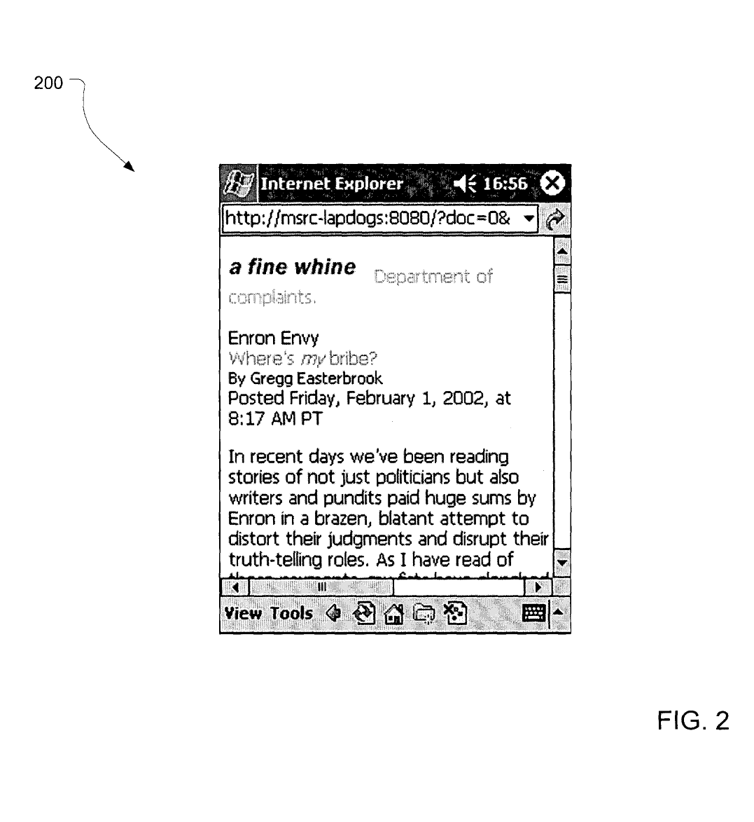

FIG. 2 depicts a logical section of the web page partition reformatted to be compatible with the display of a handheld device in an embodiment of the present invention. The handheld device display 200 displays the logical section of the web page from FIG. 1 that contained the article “a fine whine.” However, the display 200 has omitted the logical section containing the image title “Slate,” the search applet, and the advertisement. Furthermore, the logical section including the article has been reformatted to fit within the horizontal dimension (or axis) of the display 200. For example, the text of the article now wraps to new lines so that no horizontal scrolling is required. It is believed that vertical scrolling (i.e., scrolling along a vertical axis) is user-friendlier and is therefore preferable over horizontal scrolling. In this embodiment, the vertical axis is the “preferred axis” of scrolling.

However, the vertical axis need not always be the preferred axis of scrolling. In another embodiment, vertical scrolling may not be preferable. For example, if a logical section includes a panoramic image of a beach that span multiple horizontal screen areas (i.e., a short, wide photographic image), it may be preferable to size the image to fit in the full vertical dimension of the screen while requiring horizontal scrolling to view the full width of the image. In this embodiment, the horizontal axis is the preferred axis of scrolling.

In one embodiment, the user switches back to the partition map by pressing the “back” button on the browser. In another embodiment, a tap-and-hold menu can be opened that contains an option to return to the partition map. In a further embodiment, a special button is present that allows the user to jump back to the partition map. In yet another embodiment, the partition map is itself a graphical pop-up menu that the user can open, e.g., using a tap-and-hold activity or standard pull-down menus, and where logical sections can be chosen in a manner similar to textual options from a textual pop-up menu.

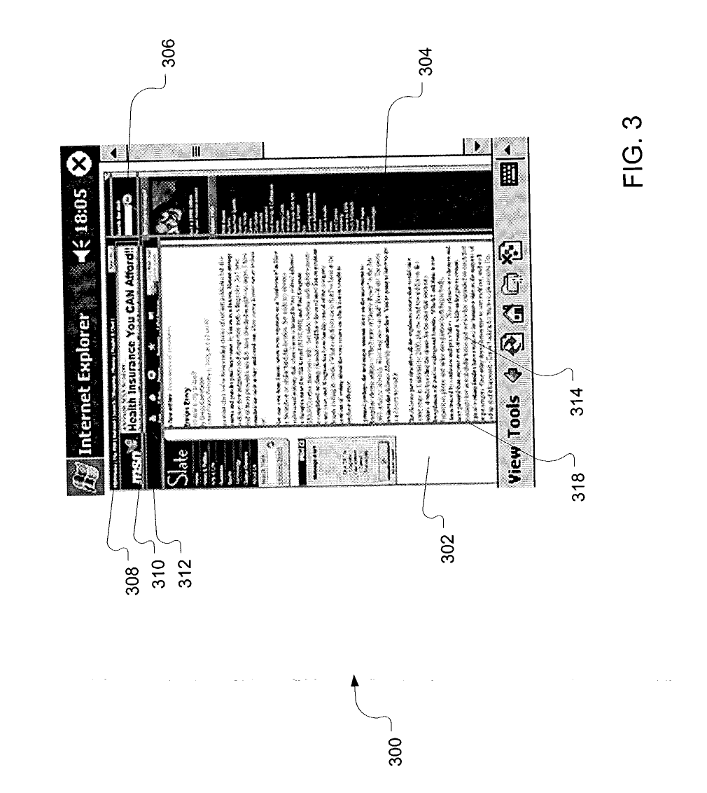

FIG. 3 depicts a web page partition map in an embodiment of the present invention. Whereas FIG. 1 displayed a web page in its originally designed dimensions and aspect ratio and FIG. 2 illustrates a single logical section of the web page reformatted to fit within the dimensions and aspect ratio of the handheld device, FIG. 3 illustrates a zoomed out version 302 of the entire web page in the handheld device display 300 that fits the width of the device and may require vertical scrolling. In another embodiment, the scaling of the page shown in FIG. 3 is such that it fits the display both horizontally and vertically. Multiple logical sections are displayed in the zoomed out version 302 of the web page, as designated by partition lines, such as line 318. The exemplary logical sections 302, 304, 306, 308, 310, 312, and 314 are all designated by partition lines separating them from other logical sections.

The display 300 illustrates a web page partition map that allows a user to select an individual logical section for viewing in the format shown in FIG. 2. A user may select a logical partition by a double tap of a stylus, a tap and hold operation using the stylus or some other pointing apparatus. Responsive to the selection, the browser displays the logical partition in a reformatted display as shown in FIG. 2.

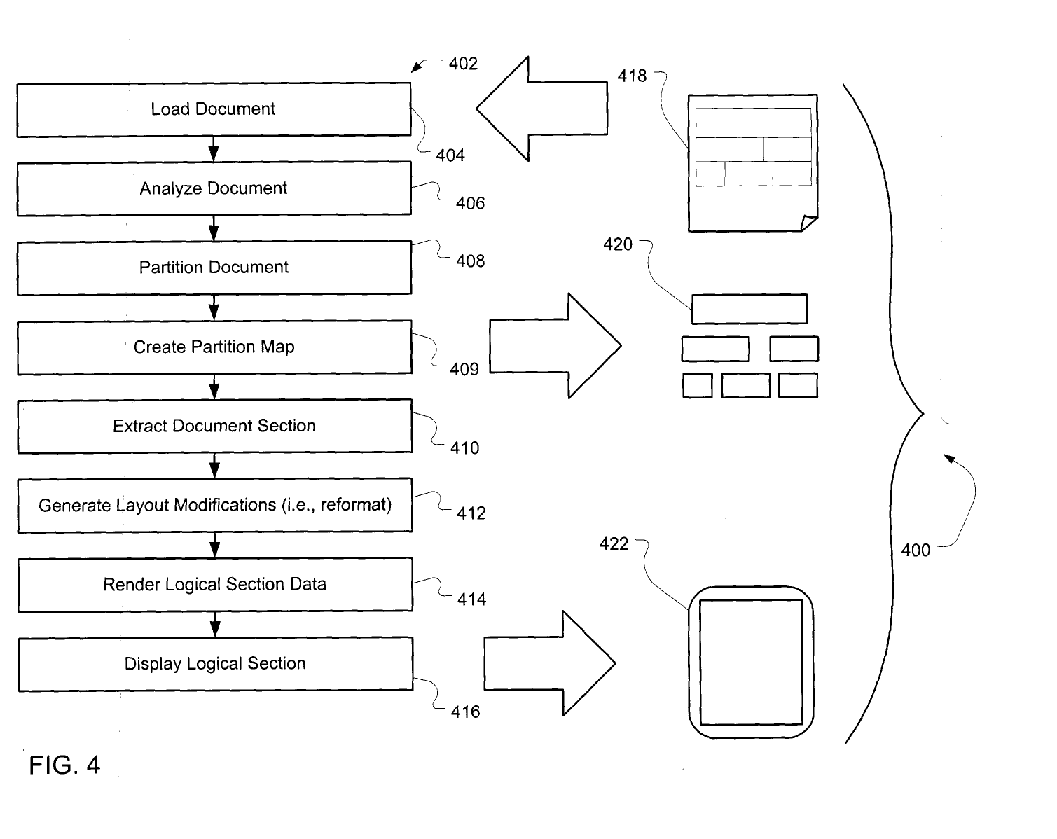

FIG. 4 illustrates a client-implemented embodiment of the present invention. The figure illustrates within brace 400 operations 402, typically executed by a client device, for partitioning and reformatting a web page for display on an incompatible display, such as a handheld device or large screen display. A loading operation 404 receives a web page document 418 and loads the document data into memory. Typically, this document includes HTML data, XML data, or other authoring language data, script data, etc. In one embodiment, individual logical sections of the document 418 are designated within the data using a table layout configuration, which is well known to web page designers.

An analysis operation 406 analyzes the document layout to identify the individual logical sections. In one embodiment, the document to be analyzed is laid out as if it was to be displayed on a desktop computer, i.e., with a page size of sufficient width that the elements in the page assume their “natural” specified size (e.g., 800 pixels wide). This standard layout of the document is also used as the basis for creating the partition map in creation operation 409.

In other alternatives, the analysis of the document layout 406 may include discovery of other properties of the content of the logical sections that can be displayed on the partition map. For example, the partition map can indicate that a particular section contains a control element, such as a form or a search box. In such embodiments, a representation of the property (such as an icon or text label) may be display in the partition map in association with the logical section.

A partitioning operation 408 partitions the document into its individual logical sections by traversing the HTML document structure or HTML Document Object Model (DOM). The DOM is a hierarchical representation of an HTML document, where each node in the DOM represents either an HTML element or a piece of text. The children of the node are all the HTML element and text nodes that are completely contained in the corresponding HTML element representing the node (e.g., a node representing a row of an HTML table is a child node of the table node, and the table cells in that row, in turn, are children of the row node).

In one embodiment, at each element node in the DOM structure, it is determined whether the node represents one of the elements that the analysis is based upon, i.e., an HTML table, a form's element, etc. If so, and if the width that the element occupies on a page is laid out for a desktop computer display (as explained above), the element is bookmarked as a possible “logical section”. If the element's width exceeds that of the target device screen (e.g., a handheld display screen) by a certain margin, processing continues with its children. Otherwise, the element's children are not further processed.

Whether a node is bookmarked as a logical section may be determined by a set of one or more predetermined rules. For example, if a table node is much wider and higher than the target device screen, the table node is not bookmarked as a logical section. Instead, all of the table node's cells are bookmarked as logical sections. In another example, if a table node's specified width (as an attribute to the HTML table element) is set to be 100% (i.e., the maximum available width) but, in its layout on the web page, the table node is within threshold amount wider than the target screen, then the table node is assumed to fit into the smaller target width of the handheld device's display. Therefore, the table node is not bookmarked as a logical section (because it “substantially” fits into the display) and neither are any of its cells.

The size of the target device screen is a parameter of both the analysis/partitioning operations and the reformatting operation (see below), and is made known to these processes in one of two ways, depending on whether these operations run locally on the device or remotely on a proxy server. If the process is running locally on the device, the dimensions of the device's screen are a system property that a program can access. Alternatively, the dimensions can be stored in and accessed from a global system storage, such as the system registry. If the process is running remotely on a proxy server, the program can access the dimensions of the target device and communicate them to the proxy server as part of the request to perform the analysis.

The result of the analysis/partitioning operation is a vector of nodes in the DOM that are the roots of logical sections. Each logical section is annotated by the region that it occupies on the standard layout of the document. This annotation information is used in a subsequent operation to mark the logical sections in the partition map.

In operation 409, the partition map is created. In one embodiment, the partition map is a thumbnail image of the full document as it would look like on a desktop screen (i.e., in a standard layout). The thumbnail is created by capturing a snapshot image from the document contents and scaling the snapshot image down to the target screen size. One method of scaling down the image involves computing for every thumbnail pixel an average color corresponding to multiple pixels in the original document image. On the partition map, the regions corresponding to the logical sections found in the document are indicated. In one embodiment, logical sections are indicated by drawing green rectangles into the thumbnail corresponding to their location and size on the thumbnail image of the document. In another embodiment, the logical sections are indicated using different colors, according to the type of the logical sections, i.e., to indicate whether a logical section is a form or whether it is a toolbar that contains a list of hyperlinks, etc. Conceptually, the logical sections shown in document 418 are now delineated, as shown in the conceptual representation of a partition map 420. Note: Delineation may be indicated in various ways, including conspicuous outlines (as shown in FIG. 3), separating logical sections (as shown in partition map 420), and by other methods.

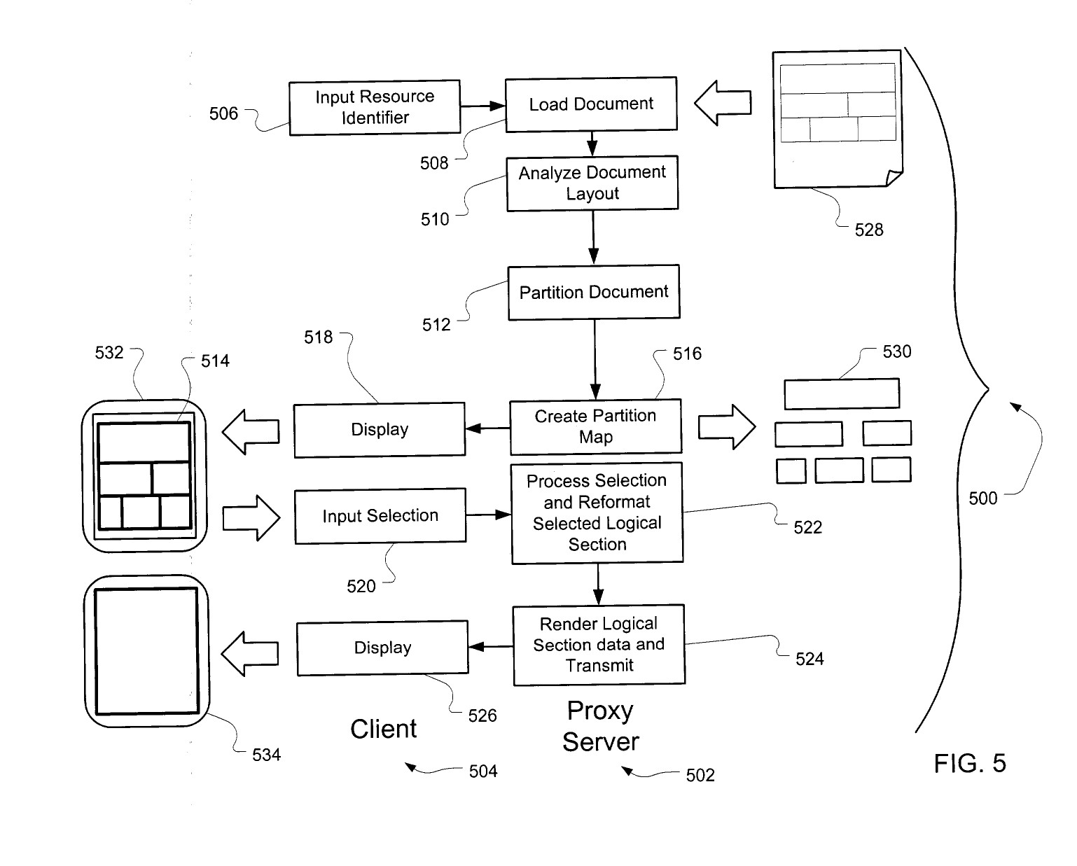

In a selection operation (not shown in FIG. 4, but shown in an alternative embodiment in FIG. 5), an individual logical section is selected by a user or via another mechanism. The selected logical section is then extracted from the document and displayed in the browser. In one embodiment, the extracted logical section is “wrapped” in a fragment HTML code in order to create a structurally and syntactically consistent but partial HTML document (because it contains only the elements contained in the logical section). In one embodiment, the fragment HTML code consists of all parts of the original HTML document along the “path” from the root node of the document down to the node that corresponds to the logical section. This way, an HTML document is obtained that is equivalent to the one where all elements except those of the logical section were omitted.

A reformatting operation 412 generates layout modifications to the logical section so that the logical section fits within the horizontal dimension (or axis) of the display. It should be understood that the reformatting operation 412 may occur before or after a selection of an individual logical section. In one embodiment, all layout elements within a logical section are forced to a width not exceeding that of the target device screen. For example, images in a logical section are scaled down proportionally to limit their width. Furthermore, in one embodiment, if the logical section is a table with several columns, it is broken apart and re-constructed using a single column, turning a side-by-side layout into a top-down layout.

Based on the selected logical section and the reformatting thereof, rendering operation 414 renders authoring language data representing the logical section. A display operation 416 displays the logical section on the handheld device display 422.

FIG. 5 illustrates a proxy server-implemented embodiment of the present invention. Within the brace 500, server operations 502, which may be performed on a proxy server, and client operations 504, such as may be performed on a handheld device, are illustrated. An inputting operation 506 receives a resource identifier, such as a Uniform Resource Identifier or “URI” through a hypertext link selection, a submission control, or an address bar in the browser. A loading operation 508 receives the URI on the server and loads the associated document 528 into memory.

An analyzing operation 510 analyzes the layout of the document, in a manner similar to the analysis operation 406 of FIG. 4. A partitioning operation 512 partitions the document into its individual logical sections by traversing the HTML DOM.

A generating operation 516 generates a web page partition map. Conceptually, the logical sections shown in document 528 are now delineated, as shown in the conceptual representation of a partition map 530. The conceptual partition map 530 is transmitted as the authoring language data representing the partition map to the client, which displays the partition map 514 in operation 518. As shown in display 532, the individual logical sections of the web page are displayed with partitioning lines in a “zoomed out” version of the web page. An inputting operation 520 receives a selection of an individual logical section (e.g., a user selection) and transmits the selection to the server.

A processing and reformatting operation 522 receives the selection and reformats the selected logical section, which is rendered and transmitted to the client in rendering operation 524. It should be understood that the reformatting operation may occur prior to receiving selection of the individual logical section (e.g., one or more logical sections of the web page are reformatted automatically prior to the selection, even if the reformatted logical section is never actually selected). A display operation 526 displays the authoring language data of the selected logical section on the handheld device display 534.

Similarly to the dedicated proxy-server implementation of the invention, the Web page processing can be done by the server hosting the page. The Web server serves the logical units of the page requested by the user directly to the device. An advantage of this implementation is that the analysis is done once per page and saves communication bandwidth. For example, the whole page never needs to be requested and delivered to the device—only its partition map is communicated to the device.

In yet another embodiment, the analysis of the Web page is done by the authoring tools, which include the analysis components. In this case, the analysis may be semi-automatic, allowing the author to modify the partitions and add meta-data to be displayed on the partition map of the page. Alternatively, the author may create a generic web page and submit it to publishing tools on a server hosting the page. This server can then provide the metadata that annotates the page for partitioning and reformatting.

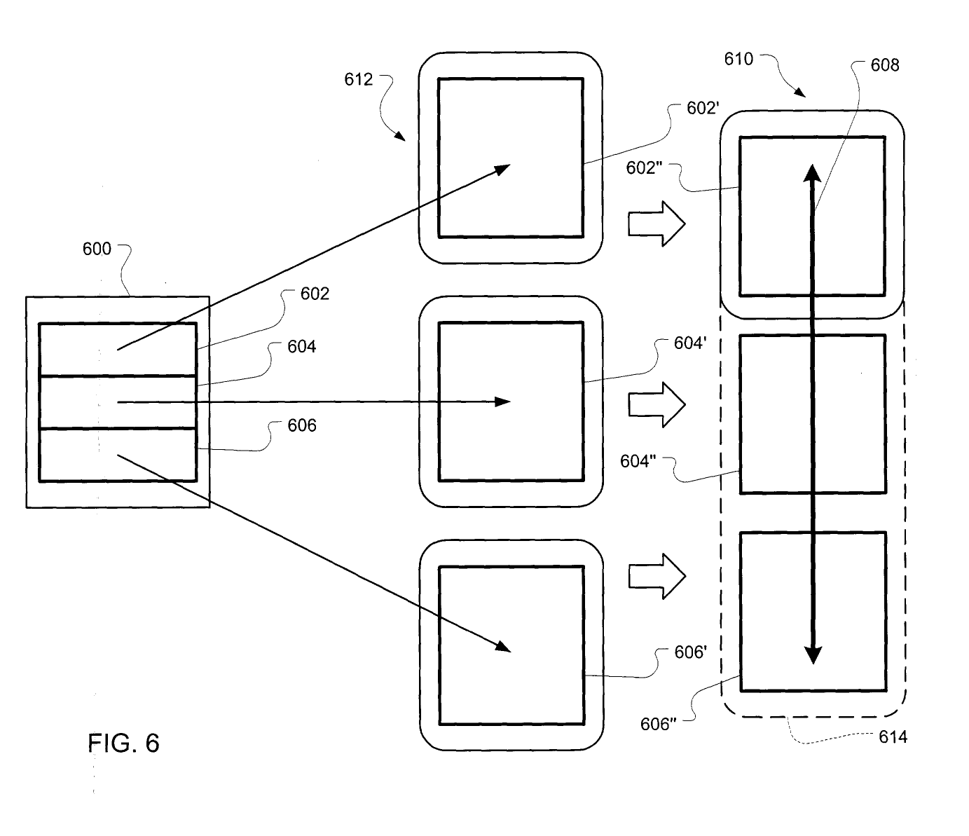

FIG. 6 illustrates exemplary heuristics for configuring logical sections of a web page in an embodiment of the present invention. A web page document 600, designed to be compatible with a desktop or laptop display, may include logical sections 602, 604, and 606, oriented as shown in FIG. 6. In one embodiment, shown at 612, individual logical sections are reformatted and may be individually selected and displayed in a handheld devices display as shown by logical section 602′, 604′, and 606′. Alternatively, an embodiment shown at 610 combines the individual reformatting logical sections into a single, vertically scrollable page, as shown by reformatted logical section 602″, 604″ and 606″ laid out in an extended virtual web page 614. In the embodiment 610, the vertical, double headed arrow 608 represents a user's ability to vertically scroll (i.e., along a vertical axis) among the three logical sections 602″, 604″, and 606″.

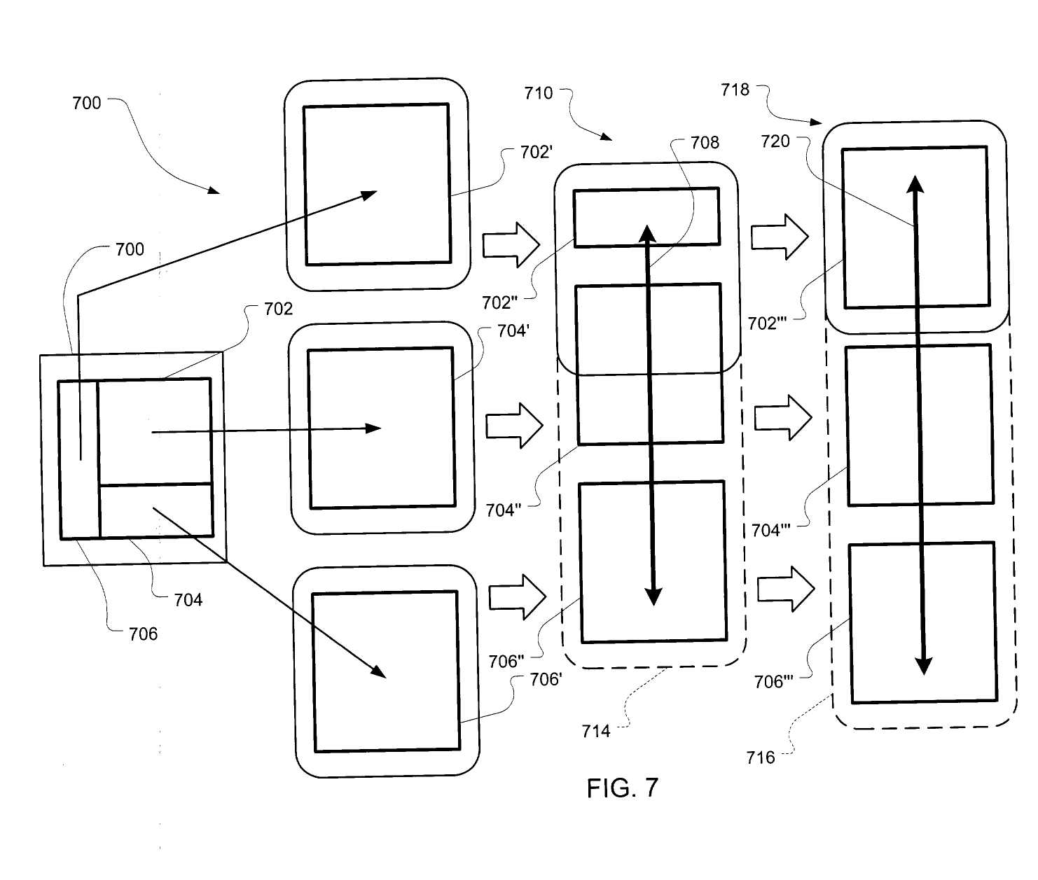

FIG. 7 illustrates other exemplary heuristics for configuring logical sections of a web page in an embodiment of the present invention. A web page document 700, designed to be compatible with a desktop or laptop display, may include logical sections 702, 704, and 706, oriented as shown in FIG. 7. In one embodiment, shown at 712, individual logical sections are reformatted and may be individually selected and displayed in a handheld devices display as shown by logical section 702′, 704′, and 706′. Alternatively, embodiments shown at 710 and 718 combines the individual reformatting logical sections into a single, vertically scrollable page, as shown by reformatted logical section 702″ and 702′″, 704″ and 704′″, and 706″ and 706′″ laid out in an extended virtual web page 714 and 716. In the embodiments 710 and 718, the vertical, double headed arrows 708 and 720 represents a user's ability to vertically scroll (i.e., along a vertical axis) among the three logical sections.

One difference between the embodiments 710 and 718 is that the logical section 706 is recognized by the partitioner as a toolbar in both embodiments. However, in embodiment 710, the toolbar logical section 702″ is shown as “folded”, whereas in embodiment 718, the toolbar logical section 702 is shown as “unfolded”, e.g., after the user has tapped on the folded section to open or unfold it, in a manner similar to pop-up menus. This folded/unfolded property represents non-layout-specific properties of a logical section that may be identified during an analysis operation and used in the display of the section.

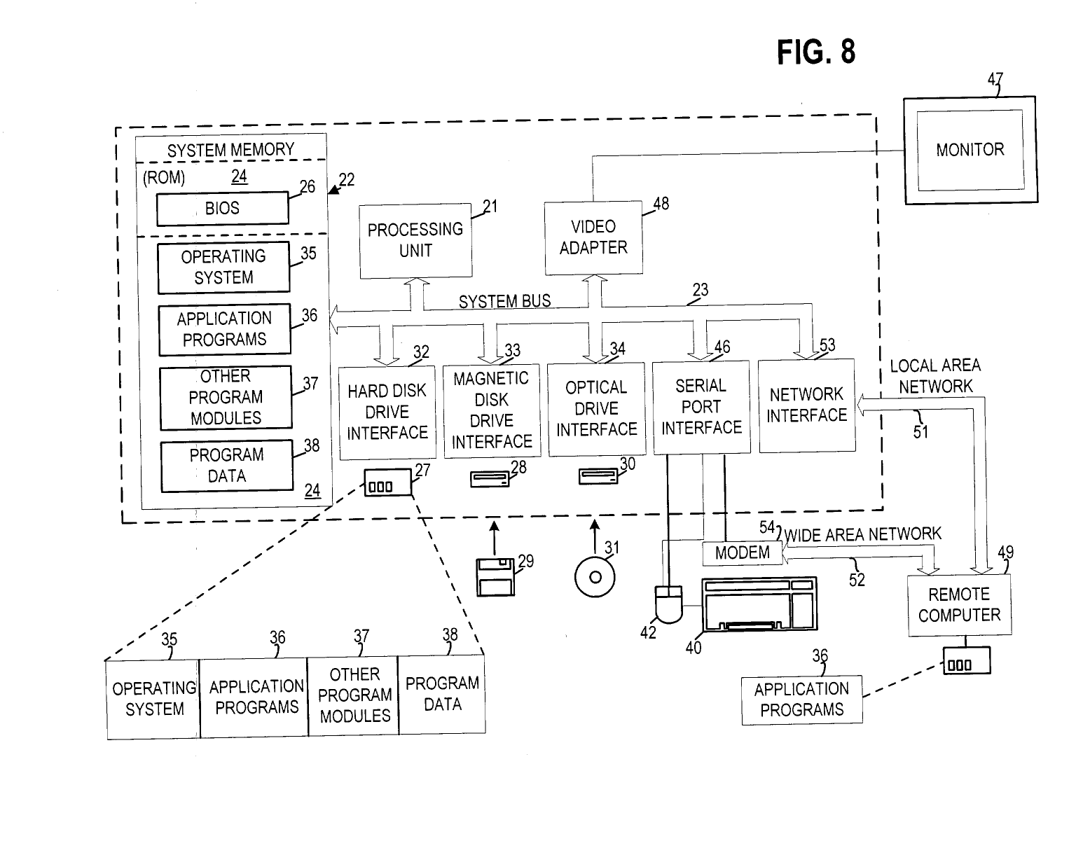

The exemplary hardware and operating environment of FIG. 8 for implementing the invention includes a general purpose computing device in the form of a computer 20, including a processing unit 21, a system memory 22, and a system bus 23 that operatively couples various system components include the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 8. The logical connections depicted in FIG. 8 include a local-area network (LAN) 51 and a wide-area network (WAN) 52. Such networking environments are commonplace in office networks, enterprise-wide computer networks, intranets and the Internal, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a type of communications device, or any other type of communications device for establishing communications over the wide area network 52, such as the Internal. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are exemplary and other means of and communications devices for establishing a communications link between the computers may be used.

In an embodiment of the present invention, a web page partitioning module, a logical section reformatting module, a map generation module, a transmission module, or a display module may be incorporated as part of the operating system 35, application programs 36, or other program modules 37. The set of heuristics rules, received or rendered authoring language data, and a web page partition map may be stored as program data 38.

The embodiments of the invention described herein are implemented as logical steps in one or more computer systems. The logical operations of the present invention are implemented (1) as a sequence of processor-implemented steps executing in one or more computer systems and (2) as interconnected machine modules within one or more computer systems. The implementation is a matter of choice, dependent on the performance requirements of the computer system implementing the invention. Accordingly, the logical operations making up the embodiments of the invention described herein are referred to variously as operations, steps, objects, or modules.

The above specification, examples and data provide a complete description of the structure and use of exemplary embodiments of the invention. Since many embodiments of the invention can be made without departing from the spirit and scope of the invention, the invention resides in the claims hereinafter appended.

What is claimed is:

1. A computer program product encoding a computer program for executing on a computer system a computer process for displaying a web page on an incompatible display having at least two axes, the computer process comprising:
partitioning the web page into one or more logical sections;
reformatting a logical section of the one or more logical sections to produce a reformatted logical section, wherein the reformatted logical section fits within the incompatible display along at least one axis when displayed in the incompatible display; and
generating data for displaying the reformatted logical partition in the incompatible display.

2. The computer program product of claim 1 wherein the computer process further comprises:
displaying the reformatting logical section in the incompatible display.

3. The computer program product of claim 4 wherein the operations of partitioning, reformatting, generating, transmitting and displaying are performed by a client device

4. The computer program product of claim 1 wherein the computer process further comprises:
transmitting the data to a browser for display in the incompatible display.

5. The computer program product of claim 4 wherein the operations of partitioning, reformatting, generating and transmitting are performed by a server device and the browser executes on a remote client device.

6. The computer program product of claim 1 wherein the computer process further comprises:
generating data for displaying a web page partition map including one or more partition lines designating the one or more logical sections of the web page.

7. The computer program product of claim 6 wherein the computer process further comprises:
receiving a selection of a desired logical section of the web page, based on the web page partition map.

8. The computer program product of claim 7 wherein the generating operation comprises:
generating the data for displaying the desired logical partition as the reformatted logical section in the incompatible display, responsive to receiving the selection of the desired logical section of the web page.

9. The computer program product of claim 1 wherein the computer process further comprises:
generating data for displaying a web page partition map including a representation of a property of one or more of the logical sections.

10. A method of displaying a web page on an incompatible display having at least two axes, the method comprising:
partitioning the web page into one or more logical sections;
reformatting a logical section of the one or more logical sections to produce a reformatted logical section, wherein the reformatted logical section fits within the incompatible display along at least one axis when displayed in the incompatible display; and
generating data for displaying the reformatted logical partition in the incompatible display.

11. The method of claim 10 further comprising:
displaying the reformatting logical section in the incompatible display.

12. The method of claim 11 wherein the operations of partitioning, reformatting, generating, transmitting and displaying are performed by a client device.

13. The method of claim 10 further comprising:
transmitting the data to a browser for display in the incompatible display.

14. The method of claim 13 wherein the operations of partitioning, reformatting, generating and transmitting are performed by a server device and the browser executes on a remote client device.

15. The method of claim 10 further comprising:
generating data for displaying a web page partition map including one or more partition lines designating the one or more logical sections of the web page.

16. The method of claim 15 further comprising:
receiving a selection of a desired logical section of the web page, based on the web page partition map.

17. The method of claim 16 wherein the generating operation comprises:
generating the data for displaying the desired logical partition as the reformatted logical section in the incompatible display, responsive to receiving the selection of the desired logical section of the web page.

18. The method of claim 10 further comprising:
generating data for displaying a web page partition map including a representation of a property of one or more of the logical sections.

19. A system for displaying a web page on an incompatible display having at least two axes, the system comprising:
a web page partitioning module partitioning the web page into one or more logical sections;
a logical section reformatting module reformatting a logical section of the one or more logical sections to produce a reformatted logical section, wherein the reformatted logical section fits within the incompatible display along at least one axis when displayed in the incompatible display; and
a logical section rendering module generating data for displaying the reformatted logical partition in the incompatible display.

20. The system of claim 19 further comprising:
a display module displaying the reformatting logical section in the incompatible display.

21. The system of claim 20 wherein the web page partitioning module, the logical section reformatting module, the logical section rendering module, and the display module reside in a client device.

22. The system of claim 19 further comprising:
a transmission module transmitting the data to a browser for display in the incompatible display.

23. The system of claim 22 wherein the web page partitioning module, the logical section reformatting module, and the logical section rendering module reside in a server device and the display module resides in a client device.

24. The system of claim 19 further comprising:
a map generation module generating data for displaying a web page partition map including one or more partition lines designating the one or more logical sections of the web page.

25. The system of claim 24 further comprising:
an selection module receiving a selection of a desired logical section of the web page, based on the web page partition map.

26. The system of claim 25 wherein the logical section rendering module generates the data for displaying the desired logical partition as the reformatted logical section in the incompatible display, responsive to receipt the selection of the desired logical section of the web page by the selection module.
